(19) United States
(12) Patent Application Publication
(10) Pub. No.: US 2014/0121991 A1
(43) Pub. Date: May 1, 2014

(54) SYSTEM AND METHOD FOR ALIGNING GENOME SEQUENCE

(71) Applicant: SAMSUNG SDS CO., LTD., Seoul (KR)

(72) Inventor: Minseo PARK, Seoul (KR)

(73) Assignee: SAMSUNG SDS CO., LTD., Seoul (KR)

(21) Appl. No.: 13/972,026

(22) Filed: Aug. 21, 2013

(30) Foreign Application Priority Data
Oct. 29, 2012 (KR) 10-2012-0120448

(51) Int. Cl. G06F 19/18

(52) U.S. Cl. CPC G06F 19/18
USPC 702/20

(57) ABSTRACT

A system and a method for aligning a genome sequence are provided. The system for aligning a genome sequence includes a fragment sequence production unit configured to produce a plurality of fragment sequences from a read, a filtering unit configured to constitute a candidate fragment sequence group including only the fragment sequences mapped to a reference sequence among the plurality of produced fragment sequences, a mapping number calculation unit configured to divide the reference sequence into a plurality of sections and calculate total mapping numbers of the candidate fragment sequences for the sections, and an alignment unit configured to select the sections in which the calculated total mapping numbers are greater than or equal to a reference number and perform global alignment on the read with respect to the selected sections.

### CROSS-REFERENCE TO RELATED APPLICATION

This application claims priority to and the benefit of Republic of Korean Patent Application No. 10-2012-0120448, filed on Oct. 29, 2012, the disclosure of which is incorporated herein by reference in its entirety.

### BACKGROUND

1. Field

The present disclosure relates to technology for analyzing a genome sequence.

2. Discussion of Related Art

A next-generation sequencing (NGS) method of producing a large amount of short sequences is rapidly replacing the conventional Sanger's sequencing method due to its inexpensive cost and rapid data generation. Also, various programs for recombining an NGS sequence have developed with a focus on accuracy. However, a cost required to construct a fragment sequence has been reduced to less than half the cost required in the past with current developments in next-generation sequencing technology. As a result, as a quantity of the data is increasingly used, technology for rapidly and accurately processing a large amount of short sequences is required.

The first operation of recombining a sequence is to map a read at an exact position of a reference sequence using an algorithm for aligning a genome sequence. In this case, it is problematic that there are differences in genomes sequence due to the presence of various genetic variations even among subjects of the same species. Also, differences in genome sequences may be caused due to errors in a sequencing process. Therefore, the algorithm for recombining a genome sequence has to effectively enhance mapping accuracy in consideration of the differences in genome sequences and the genetic variations.

In conclusion, as much data on the entire genomic information as possible is required so as to analyze the genomic information. For this purpose, development of an algorithm for recombining a genome sequence, which has excellent accuracy and high throughput, should also be achieved in advance. However, the conventional methods have limits in satisfying these requirements.

### SUMMARY

The present disclosure is directed to a means for aligning a genome sequence capable of ensuring mapping accuracy and simultaneously improving complexity upon mapping to increase a processing rate.

According to an aspect of the present disclosure, there is provided a system for aligning a genome sequence, which includes a fragment sequence production unit configured to produce a plurality of fragment sequences from a read, a filtering unit configured to constitute a candidate fragment sequence group including the fragment sequences mapped to a reference sequence among the plurality of produced fragment sequences, a mapping number calculation unit configured to divide the reference sequence into a plurality of sections and calculate total mapping numbers of the candidate fragment sequences for the sections, and an alignment unit configured to select the sections in which the calculated total mapping numbers are greater than or equal to a reference number and perform global alignment on the read with respect to the selected sections.

According to another aspect of the present disclosure, there is provided a method of aligning a genome sequence, which includes producing a plurality of fragment sequences from a read at a fragment sequence production unit, constituting a candidate fragment sequence group including only the fragment sequences mapped to a reference sequence among the plurality of produced fragment sequences at a filtering unit, dividing the reference sequence into a plurality of sections and calculating total mapping numbers of the candidate fragment sequences for the respective sections at a mapping number calculation unit, and selecting the sections in which the calculated total mapping numbers are greater than or equal to a reference number and performing global alignment on the read with respect to the selected sections at an alignment unit.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a diagram explaining a method 100 of aligning a genome sequence according to one exemplary embodiment of the present disclosure;

FIG. 2 is a diagram exemplifying a process of calculating an error margin e (Operation 108) in the method of aligning a genome sequence according to one exemplary embodiment of the present disclosure;

FIG. 3 is a diagram explaining a process of producing a fragment sequence (Operation 112) in the method of aligning a genome sequence according to one exemplary embodiment of the present disclosure;

FIG. 4 is a diagram exemplifying a process of selecting a mapping target section in a reference sequence according to one exemplary embodiment of the present disclosure;

FIG. 5 is an exemplary diagram explaining a method of reducing the cycles of unnecessary global alignments upon global alignment according to one exemplary embodiment of the present disclosure; and

FIG. 6 is a block diagram showing a system 600 of aligning a genome sequence according to one exemplary embodiment of the present disclosure.

### DETAILED DESCRIPTION OF EXEMPLARY EMBODIMENTS

Exemplary embodiments of the present disclosure will be described in detail below with reference to the accompanying drawings. While the present disclosure is shown and described in connection with exemplary embodiments thereof, it will be apparent to those skilled in the art that various modifications can be made without departing from the scope of the present disclosure.

Also, descriptions of well-known functions and constructions may be omitted for increased clarity and conciseness. In addition, terms described below are terms defined in consideration of functions in the present disclosure and may be changed according to the intention of a user or an operator or conventional practice. Therefore, the definitions must be based on content throughout this disclosure.

Prior to describing the exemplary embodiments of the present disclosure in detail, first, the terminology used herein will be described in advance, as follows.

First, the term “read sequence” (or abbreviated as “read”) refers to genome sequence data having a short length, which is output from a genome sequencer. Reads generally vary in length ranging from approximately 35 to 500 bp (base pairs) according to the kind of a genome sequencer. In general, DNA bases are represented by four characters: A, C, G, and T.

The term “reference sequence” refers to a genome sequence used for reference to produce a full-length genome sequence from the reads. In analysis of the genome sequence, a large amount of reads output from a genome sequencer are mapped with reference to the reference sequence to complete the full-length genome sequence. According to the present disclosure, the reference sequence may be a sequence (for example, a full-length human genome sequence, etc.) set in advance upon analysis of a genome sequence, or a genome sequence synthesized in a genome sequencer may be used as the reference sequence.

The term “base” refers to a basic unit constituting a reference sequence and a read. As described above, the DNA bases may be composed of four letters: A, C, G, and T, each of which is referred to as a base. That is, the DNA bases are represented by four bases. Likewise, this is applicable to the read.

The term “fragment sequence” (or seed) refers to a sequence which is a basic unit used when a read is compared with a reference sequence so as to map the read. In theory, mapping positions of reads should be calculated while sequentially comparing the entire read with the reference sequence beginning from the 1st base of the reference sequence so as to map the read to the reference sequence. However, such a method has a problem in that large amounts of time and computing power are required to map one read. Therefore, a fragment sequence that is a piece that is actually composed of a portion of the read is first mapped to the reference sequence to search for a mapping candidate position of the entire read and map the entire read at a corresponding candidate position (global alignment).

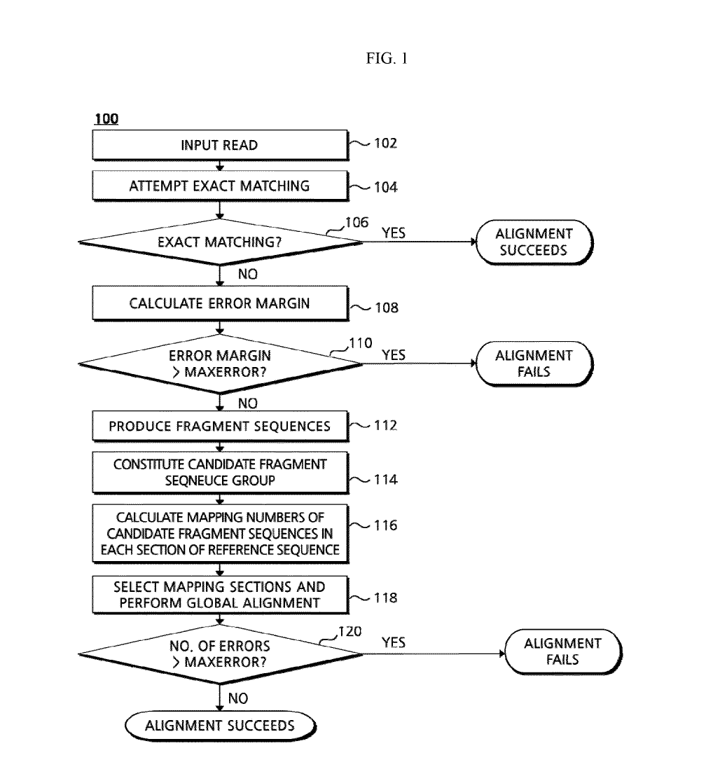

FIG. 1 is a diagram explaining a method 100 of aligning a genome sequence according to one exemplary embodiment of the present disclosure. According to one exemplary embodiment of the present disclosure, the method 100 of aligning a genome sequence refers to a series of processes including comparing reads output from a genome sequencer with a target genome sequence and determining a mapping (or aligning) position of the read on the target sequence.

First, when a read is input from a genome sequencer (Operation 102), exact matching of the entire read with the target genome sequence is attempted (Operation 104). From the results of this attempt, when the exact matching of the entire read succeeds, the alignment is judged to have succeeded without performing an alignment operation (Operation 106). From the results of experiments on human genome sequences, when 1,000,000 reads output from a genome sequencer are exactly matched with the human genome sequences, 231,564 cycles of the exact matching appear to take place in a total of 2,000,000 alignments (1,000,000 alignments for a forward sequence, and 1,000,000 alignments for a reverse complementary sequence). Therefore, the results obtained in Operation 104 show that a work load required for the alignments may be reduced by approximately 11.6%.

On the other hand, when the corresponding read is judged not to be exactly matched in Operation 106, an error margin e, which may occur when the corresponding read is aligned on the target sequence, is calculated (Operation 108).

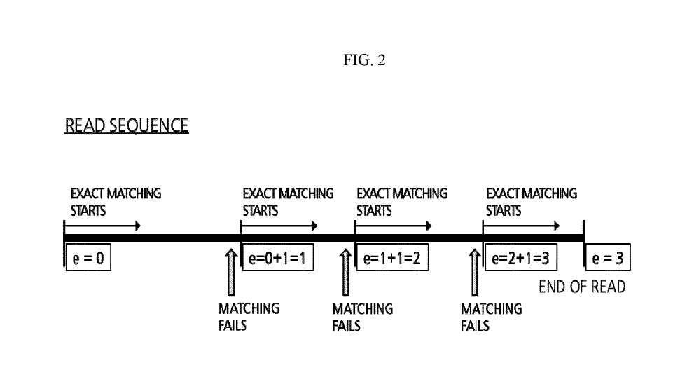

FIG. 2 is a diagram exemplifying a process of calculating an error margin e in Operation 108. As shown in FIG. 2, an initial error margin is first set to 0 (e=0), and exact matching is attempted while migrating from a 1st base of a read one by one in a right direction. In this case, if it is assumed that further exact matching from a certain base (a base indicated by a 1st arrow from the left in the drawing) of the read is impossible to perform, this means that an error takes place somewhere in a section spanning from a matching start position to a current position of the read. Therefore, the error margin is increased by one accordingly (e=1), and new exact matching starts at the next position. Next, when the exact matching is judged to be impossible to perform again, another error takes place somewhere in another section spanning from a position at which the exact matching re-starts to a current position. As a result, the error margin is increased again by one (e=2), and new exact matching starts at the next position. The error margin (e=3 in the drawing) when the end of the read is reached through such a process becomes the number of errors that may occur in the corresponding read. In this case, the value e is an error margin because the number of all the errors that may occur in the read is not investigated, but is inspected only at one position of a target sequence using a method of performing new exact matching from a point of time at which an error occurs at a certain site in the read. That is, the value e may be a minimum value of errors that may occur in the corresponding read, and more errors may occur in other sites of the target sequence.

When the error margin of the read is calculated through such a process, it is judged whether the calculated error margin exceeds a predetermined maximum error allowable value (maxError) (Operation 110). When the calculated error margin exceeds the maximum error allowable value, alignment of the corresponding read is judged to have failed, and the alignment is then terminated. In the above-described experiments on the human genome sequences, when the error margins of the other reads are calculated on the assumption that the maximum error allowable value (maxError) is set to 3, it is shown that the error margins of the reads corresponding to a total of 844,891 cycles exceed the maximum error allowable value. That is, the results obtained in Operation 108 show that a work load required for the alignments may be reduced by approximately 42.2%.

On the other hand, when the results of the judgment in Operation 110 show that the calculated error margin is less than or equal to the maximum error allowable value, alignment on the corresponding read is performed as follows.

First, a plurality of fragment sequences are produced from the read (Operation 112), and a candidate fragment sequence group including only the fragment sequences matching the reference sequence is constituted from the plurality of produced fragment sequences (Operation 114). Then, the reference sequence is divided into a plurality of sections, and total mapping numbers of the candidate fragment sequences in each of the sections are calculated (Operation 116). From the results of the calculation, the sections in which the total mapping numbers are greater than or equal to the reference number are selected, and global alignment on the read with respect to the selected sections is performed (Operation 118). In this case, when the results of the global alignment show that the error margin of the read exceeds the predetermined maximum error allowable value (maxError), the alignment is judged to have failed, and the alignment is judged to have succeeded when the error margin of the read does not exceed the maximum error allowable value (Operation 120).

Hereinafter, specific processes including Operations 112 to 118 will be described in detail.

Producing a Plurality of Fragment Sequences from Read (Operation 112)

This operation is in earnest to produce fragment sequences which are a plurality of small pieces from a read so as to perform alignment on the read. In this operation, the fragment sequences are produced by a predetermined size (a fragment size) while migrating from a 1st base to the last base of the read by a predetermined shift size.

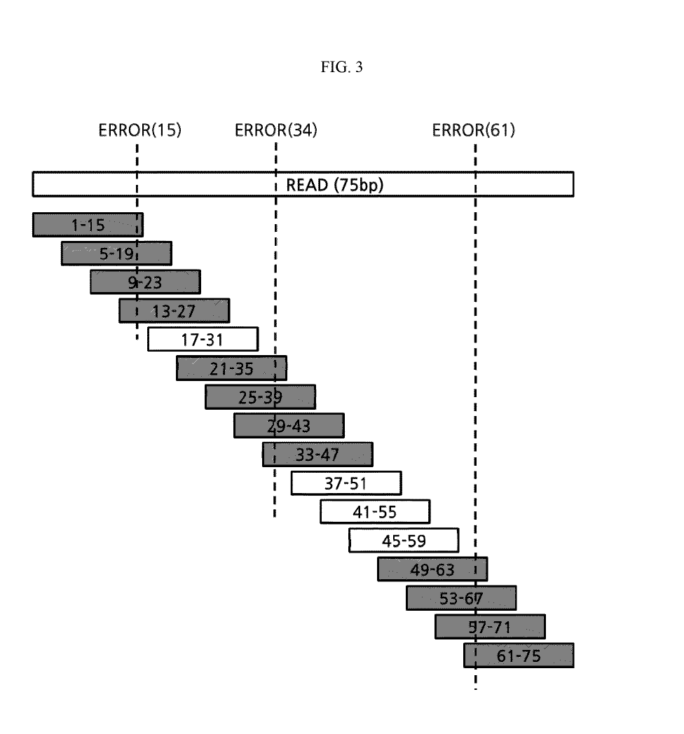

FIG. 3 is a diagram explaining a process of producing a fragment sequence (Operation 112). One exemplary embodiment in which a read has a length of 75 bp (base pairs) and a maximum error allowable value of 3 bp, and a fragment sequence has a fragment size of 15 bp and a shift size of 4 bp is shown in the exemplary embodiment shown in FIG. 3. That is, the fragment sequences are produced while migrating from the 1st base of the read by 4 base pairs in a right direction. However, the exemplary embodiment shown in FIG. 3 is described for the purpose of illustrations only, and thus the shift size and the fragment sizes of the fragment sequences may be, for example, properly adjusted in consideration of the length of the read sequence, the maximum error allowable value of the read, etc. That is, it is noted that the scope of the present disclosure is not particularly limited to the fragment sizes of the fragment sequences and the shift size.

Filtering and Expanding Produced Fragment Sequences (Operation 114)

When the fragment sequences are produced through such a process, a filtering process of excluding the fragment sequences, which does not match the reference sequence, from the produced fragment sequences is performed to constitute a candidate fragment sequence group (a sub-candidate group). That is, exact matching of the produced fragment sequences with the reference sequence is attempted, and thus the fragment sequences (candidate fragment sequences) in which the number of unmatched bases is less than or equal to a predetermined allowable value are constituted into the candidate fragment sequence group. In this case, when the allowable value is set to a null (0), only the fragment sequences matching the reference sequence are included in the candidate fragment sequence group.

According to the exemplary embodiment shown in FIG. 3, for example, it is assumed that errors occur at 15^{th}, 34^{th} and 61^{st} positions of the read (shown in grey in the drawing). In this case, the fragment sequences carrying the errors (shown in grey in the drawing) do not exactly match the reference sequence, but the four 17^{th}-to-31^{st}, 37^{th}-to-51^{st}, 41^{st}-to-55^{th} and 45^{th}-to-59^{th} fragment sequences which are not affected by the errors exactly match the reference sequence. As a result, only the above-described four fragment sequences are included in the candidate fragment sequence group.

In general, the reference sequence (for example, a human genome) includes a number of repeat sequences. Such repeat sequences are distributed at various positions of the target sequence, and repeatedly include the same genome sequence. As a result, when some fragment sequences are mapped to the target sequence, the exact matching occurs at a plurality of positions. However, when the great number of mapping positions occurs in some fragment sequences due to the present such a repeat sequence, this has an adverse effect on complexity and accuracy of the algorithm for recombining a Rill-length sequence. Therefore, it is necessary to reduce the mapping repeat numbers of the fragment sequences using a suitable method.

For this purpose, when there are the fragment sequences in which the mapping repeat numbers in the reference sequence exceeds a predetermined value (for example, 50) among the candidate fragment sequences, this operation may further include expanding a fragment size of the corresponding fragment sequence until the mapping repeat number reaches a value less than or equal to the predetermined number.

More particularly, in this operation, the number of the mapping positions of the produced candidate fragment sequences in the reference sequence is calculated, the fragment sequences in which the calculated mapping repeat numbers (the number of the mapping positions of the corresponding fragment sequences in the reference sequence) exceeds the predetermined number are selected, and a fragment size of the selected fragment sequence is expanded until the mapping repeat numbers in the reference sequence reaches a value less than or equal to the predetermined number. In this case, the size expansion of the selected fragment sequences may be performed by adding or appending bases in the read corresponding to the corresponding positions to the beginnings or ends of the selected fragment sequences.

One example of the size expansion will be described as follows. For example, it is assumed that a fragment sequence is produced from a read as follows.

Read: A T T G C C T C A G T
Fragment sequence: T T G C
(the underlined sequence in the read)

When the mapping result for the fragment sequence shows that the mapping repeat number in a target sequence is 65, which exceeds a reference value of 50, a length of the fragment sequence is expanded by one base pair until the mapping repeat number reaches a value less than or equal to the reference value, as follows.

T T G C (65 mapping positions)
T T G C C (54 mapping positions)
T T G C C T (27 mapping positions)

In this example, when two bases are added with reference to the read, the mapping repeat number decreases to a value less than or equal to the predetermined value. As a result, the final fragment sequence becomes a sequence of T T G C C T, whose length is 2 base pairs longer than the initial length of the read. Meanwhile, like another example described above, the predetermined value may also be properly determined according the characteristics of the reference sequence, the read and the fragment sequence. Therefore, it should be noted that a certain value of the mapping repeat number is not intended to limit the scope of the present disclosure.

In the experiments on the human genome sequences, when fragment sequences having a length of 15 bp are produced at a shift size of 4 bp from 1,000,000 reads and the produced fragment sequences are matched with a target sequence, it was revealed that approximately 77% of a total of 15,547,856 fragment sequences have 50 or fewer mapping positions on the assumption that a reference value is set to 50. That is, the experimental results show that 77% of the fragment sequences may be used without base addition, and the remaining 23% of the fragment sequences have to be subjected to fragment sequence expansion using the above-described method when the reference value is set to 50.

Calculating Mapping Repeat Numbers for Each Section of Reference Sequence (Operation 116)

When the candidate fragment sequence group (that is, a sub-candidate group) is constituted through such a process, it is basically possible to map a read to the reference sequence using the mapping positions of the candidate fragment sequence assemblies in the reference sequence. In this case, however, since all combinations of the mapping positions of the candidate fragment sequences have to be contemplated, complexity in calculation used to map a read is excessively high. For example, when the number of the candidate fragment sequences included in the candidate fragment sequence group is 4, and the numbers of the mapping positions of the candidate fragment sequences in the reference sequence 3, 6, 24 and 49, respectively, 21,168 combinations (=3*6*24*49) of the mapping positions should be examined. According to the present disclosure, to reduce such complexity in calculation, a method of dividing the reference sequence into a plurality of sections and performing global alignment on only the sections having high mapping probability is used herein.

That is, in the present disclosure, the reference sequence is first divided into a plurality of sections having the same fragment size, and the following values are calculated for each section.

A: Total mapping numbers of candidate fragment sequences which are mapped to a corresponding section; and

B: Total mapping lengths of the candidate fragment sequences which are mapped to the corresponding section

For example, according to the exemplary embodiment shown in FIG. 3, when the 17^{th}-to-31^{st} fragment sequence is mapped to the first divided section, a value (A, B) of the corresponding section becomes (1, 15) (here, the integer “1” represents a total number of the candidate fragment sequences mapped to the corresponding section, and the integer “15” represents a total mapping length of the candidate fragment sequences mapped to the corresponding section). In the same way, when the 37^{th}-to-51^{st} fragment sequence is mapped to the second divided section, a value (A, B) of the corresponding section becomes (1, 15). Finally, when the 41^{st}-55^{th} fragment sequence is again mapped to the second divided section, a value (A, B) of the corresponding section is updated to (2, 19). This reason is described as follows.

First value: 2 which is the number of the candidate fragment sequences mapped to the corresponding section; and

Second value: 19 which is a total mapping length considering an overlapping section between a 37^{th}-to-51^{st} fragment sequence mapped at the beginning and a 41^{st}-to-55^{th} fragment sequence mapped thereafter.

Selecting Mapping Target Section and Performing Global Alignment on Mapping Target Section (Operation 118)

When the mapping numbers of and mapping lengths of the respective sections are calculated through such a process, the sections in which the mapping numbers are greater than or equal to a predetermined reference number are selected as the mapping target sections from the respective sections. Also, when the sections in which the mapping numbers are greater than or equal to the reference number are present in plural numbers, the sections in which the total mapping lengths are greater than or equal to the predetermined reference number may be selected as the mapping target sections from the sections in which the total mapping number are greater than or equal to the reference number. In this case, the reference number should be at least 2. This is because a section to which only one fragment sequence is mapped has a low probability of mapping reads when considering that a basic mapping unit is a fragment sequence. The reference length will be described later in further detail.

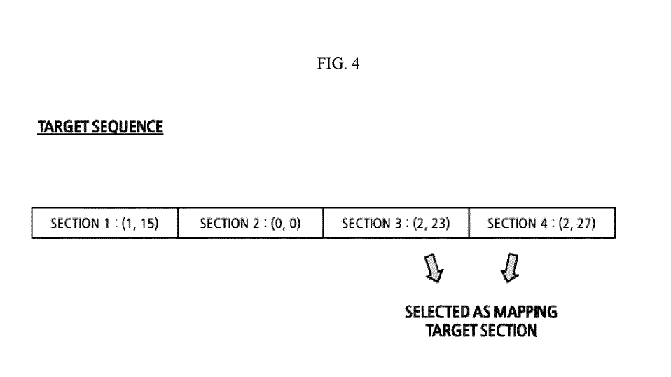

FIG. 4 is a diagram illustrating a process of selecting a mapping target section according to one exemplary embodiment of the present disclosure. As shown in FIG. 4, it is assumed that the reference sequence is divided into four sections: Sections 1 to 4, and the mapping numbers and mapping lengths of the respective sections are calculated as follows.

Section 1=(1, 15)

Section 2=(0, 0)

Section 3=(2, 23)

Section 4=(2, 27)

In this case, when the reference number is set to 2 and the reference length is set to 22, the sections satisfying the requirements regarding the reference number and the reference length are Sections 3 and 4. As a result, the sections corresponding to Sections 3 and 4 are selected as the mapping target sections in this operation. In this case, all the sections corresponding to a case in which the sections satisfying the requirements regarding the reference number and the reference length are present in plural number become the mapping target sections, and the global alignment is performed on all the plurality of sections included in the mapping target sections. In this case, to enhance an alignment rate, the mapping numbers or mapping lengths of the respective sections included in the mapping target section may be compared with each other, and the global alignment may be sequentially performed starting from the sections having a high mapping number or mapping length. This is because that, when the sections have a high mapping number or mapping length, the read may be mapped to the corresponding section with high probability. According to the exemplary embodiment, for example, since Sections 3 and 4 have the same mapping number of 2 but Section 4 has a higher mapping length than Section 3, the global alignment may be performed from Section 4.

When the mapping target section is selected as described above, the candidate fragment sequences mapped to the corresponding mapping target section among the candidate fragment sequences (sub-candidates) are finally selected as the candidate fragment sequences (candidates), and the global alignment on the read at the mapping positions of the finally selected candidate fragment sequences are performed to complete the alignment on the read.

According to the exemplary embodiment shown in FIG. 4, for example, when it is assumed that the number of the candidate fragment sequences mapped to Section 4 is 3: 37^{th}-to-51^{st}, 41^{st}-to-55^{th}, and 45^{th}-to-59^{th} fragment sequences, the three candidate fragment sequences become the final candidates, and the global alignment on the read at mapping positions of the corresponding sections of the final candidates is then performed.

Meanwhile, to reduce a time required to perform the global alignment, a position in the reference sequence at which the global alignment is performed once are memorized upon global alignment on the final candidate fragment sequence so as to prevent the global alignment from being repeatedly performed at other positions adjoining such a position. More particularly, when the mapping target section is divided into a plurality of subsections and the global alignment is performed on the subsections, such global alignment on the subsections is recorded in this operation. Thereafter, upon the global alignment on the corresponding subsection, the recorded information may be used to judge whether the global alignment is pre-performed in the corresponding subsection, and the global alignment on the corresponding subsection may be performed only when the judgment results show that the global alignment is not pre-performed.

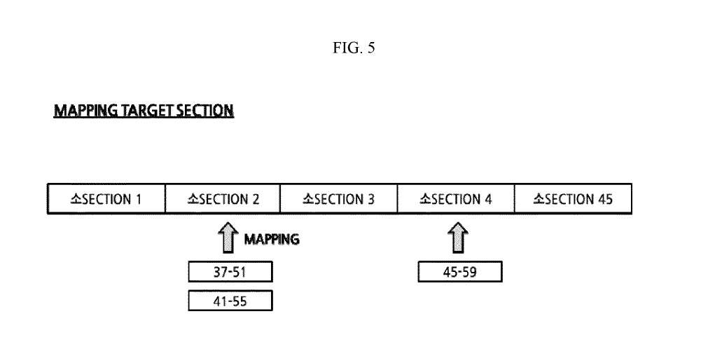

For example, this operation will be described later as shown in FIG. 5. As shown in FIG. 5, it is assumed that the mapping target section is divided into five subsections, and the 37^{th}-to-51^{st} and 41^{st}-to-55^{th} fragment sequences of the three final candidate fragment sequences are mapped to a 2^{nd} subsection and the 45^{th}-to-59^{th} fragment sequences is mapped to a 4^{th} subsection. When global alignment on the 37^{th}-to-51^{st} fragment sequence is performed in the 2^{nd} subsection, global alignment on the 41^{st}-to-55^{th} fragment sequence belonging to the same subsection is not performed regardless the results of the global alignment. Likewise, this is applicable to the reverse case. Therefore, according to the exemplary embodiment shown in FIG. 5, the global alignment is performed on a combination of the 37^{th}-to-51^{st} and 45^{th}-to-59^{th} fragment sequences or a combination of the 41^{st}-to-55^{th} and 45^{th}-to-59^{th} fragment sequences. Although the global alignment is performed only in the mapping target section rather than the entire reference sequence as disclosed in the present disclosure, a large amount of time is required to perform the global alignment. As a result, a time required to align a full-length genome sequence may be drastically reduced through such a process.

Calculating Reference Length

According to the exemplary embodiments, the reference length may be calculated, as follows.

First, when it is assumed that f represents a fragment size of a fragment sequence, s represents a shift size in a read to produce the fragment sequence, L represents a length of the read, e represents a maximum error margin allowable in the read, and H represents a reference length, a length T of a domain which is not affected by the errors in the read may be calculated as represented by the following equation.

T=L−f*e−s

In this case, since L and e are values which may be determined in advance upon practice of the present disclosure, T is determined according to the values f and s. That is, performance of the algorithm varies depending on how the values f and s are changed.

First, the following two requirements are taken into consideration when determining the value H. Among these, the essential requirements should be satisfied without exception, and additional requirements are taken into consideration as necessary.
Essential requirements: Since a basic mapping unit is a fragment sequence, a reference length should have a suitable size to cover at least two overlapping fragment sequences no matter how small the reference length may be. When f=15 and s=4 as shown in FIG. 2, since the sum of the minimum lengths of the two overlapping fragment sequences is 19 (15+4), the value H should be at least 19. Also, since the value H is set to cover at least two fragment sequences, the value H should be at least greater than or equal to a value of f+s. As will be described later, since the value f should be greater than or equal to 15, the value H becomes at least 16 (15+1) on the assumption that the value s is 1 which is the minimum value.
Additional requirements: When a section in which the values H and T are set to be H=T and to which sequences having a size greater than or equal to the value T are mapped is found on the assumption of the ideal conditions, all the mapping positions of given errors may be found. However, when there are many redundancies of the reference sequence as described above, there may be a case of expanding the length of the fragment according to the situations. Therefore, when the value H is determined in consideration of these facts, it is desirable in an aspect of a mapping rate to use a value of T−s which is slightly less than T. When it is assumed that the value H is equal to T, the equation, H=L−f*e−s, is established. Also when the value e is 1 that is the minimum value (the mapping is completed in Operation 104 as described above since a target sequence is exactly matching the reference sequence when the value e is 0), the equation, H=L−f−s, is established. This value becomes the maximum value of the reference length. When it is assumed that L=75 bp, f=15 bp, and s=1, the maximum H value becomes 59 (75−15−1).

In summary, the value H should be satisfied within the following range.

f+s≦H≦L−(f+s)

Subsequently, the value f selects the higher one of values satisfying the following two requirements. Also, the essential requirements should be necessarily satisfied, and the additional requirements are contemplated if possible.
Essential requirements: The value f should be greater than or equal to 15. This is because the number of the mapping positions in the reference sequence drastically increases when the fragments have a length of 14 or less.

The following Table 1 lists the average frequencies of occurrence of the fragment sequence in the human genome according to the length of the fragment sequence.

TABLE 1

| Fragment sequence length (bp) | Average frequencies of occurrence |
|---|---|
| 10 | 2,726.1919 |
| 11 | 681.9731 |
| 12 | 170.9185 |
| 13 | 42.7099 |
| 14 | 10.6470 |
| 15 | 2.6617 |
| 16 | 0.6654 |
| 17 | 0.1664 |

As listed in Table 1, it could be seen that the frequency of the fragment sequence is 10 or more when the fragment sequence has a length of 14 or less, but decreases to 3 or less when the fragment sequence has a length of 15. That is, when the fragment sequence is constituted to have a length of 15 or more, redundancies of the fragment sequence may be drastically reduced compared with a case in which the fragment sequence is constituted to have a length of 14 or less.
Additional requirements: The equation f=L/(e+2) should be satisfied so as to ensure that the length T corresponds to the sum of fragment sizes of two fragment sequences.

For example, when L=100, and e=4, then the value f should be less than or equal to 16.

A method of summarizing the above-described requirements and determining the values f, s and H are summarized, as follows.
The value s is fixed to 4, and the values f and H are then determined
The highest value is determined to be f in a range of 15≦f≦L/(e+2) (here, it is necessary to satisfy f=15)
H is determined using the following equation.

The higher one of the values calculated by the equation: H=L−f*e−2s or H=f+s.

(wherein H represents a reference value, L represents a length of a read, f represents a length of a fragment sequence, e represents a maximum error margin of the read, and s represents a shift size between the fragment sequences)

### Example 1

### When it is Assumed that L=75 and e=3

f=15 to 15, that is, 15,

s=4, and

H=75−3*15−2*4=22.

### Example 2

### When it is Assumed that L=100, and e=4

f=15 to 16, that is, 16,

s=4, and

H=100−4*16−2*4=36−8=28.

### Example 3

### When it is Assumed that L=75, and e=4

f=15 to 12, that is, 15, since the value f should be greater than or equal to 15,

s=4, and

H=75−4*15−2*4=15−8=7, but H=19 since f+s=19.

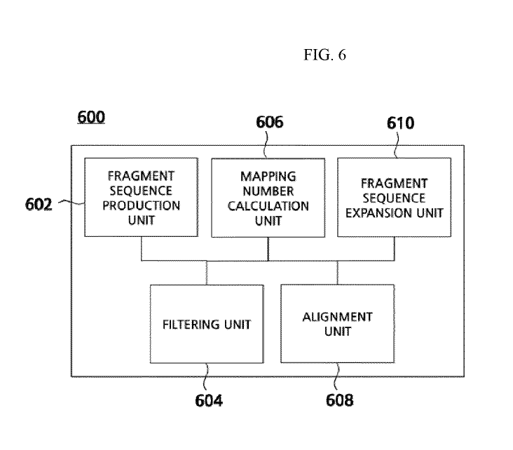

FIG. 6 is a block diagram showing a system 600 for aligning a genome sequence according to one exemplary embodiment of the present disclosure. The system 600 of aligning a genome sequence according to one exemplary embodiment of the present disclosure is a device for performing the above-described method of aligning a genome sequence, and includes a fragment sequence production unit 602, a filtering unit 604, a mapping number calculation unit 606, an alignment unit 608 and a fragment sequence expansion unit 610.

The fragment sequence production unit 602 produces a plurality of fragment sequences from a read obtained in a genome sequencer. As described above, the fragment sequence production unit 602 produces the fragment sequences by reading a value of the read by a predetermined size while migrating from a 1st base of the read sequence by a predetermined shift size.

The filtering unit 604 constitutes a candidate fragment sequence group including only the fragment sequences mapped to the reference sequence among the plurality of produced fragment sequences. In this case, the fragment sequences mapped to the reference sequence refers to fragment sequences in which the number of unmatched bases is less than or equal to a predetermined number as seen from the results of exact matching with the reference sequence.

The mapping number calculation unit 606 divides the reference sequence into a plurality of sections, and calculates mapping positions of the candidate fragment sequences for each of the sections and total mapping numbers the candidate fragment sequences for each of the sections.

The alignment unit 608 selects the sections in which the calculated total mapping numbers are greater than or equal to a reference number among the sections divided at the mapping number calculation unit 606, and performs global alignment on the read with respect to the selected sections. More particularly, the alignment unit 608 performs the global alignment on the read based on the mapping position in the reference sequence of the candidate fragment sequence mapped to the selected sections among the candidate fragment sequences.

Also, the alignment unit 608 may be configured to divide the selected section (a mapping target section) into a plurality of subsections, judge whether the global alignment is pre-performed in the subsections to which positions in the reference sequence on which the global alignment is to be performed belong, and perform the global alignment only when the global alignment is not pre-performed from the judgment results, thereby reducing unnecessary cycles of the global alignment.

The fragment sequence expansion unit 610 calculates mapping repeat numbers in the reference sequence of the candidate fragment sequences produced at the filtering unit 604, selects the fragment sequences in which the calculated mapping repeat numbers exceed the predetermined number, and expands fragment sizes of the selected fragment sequences at the fragment sequence expansion unit until the mapping repeat numbers in the reference sequence reaches a value less than or equal to the predetermined number. In this case, the fragment sequence expansion unit 610 may perform the size expansion by adding bases in the read corresponding to the corresponding positions to the beginnings or ends of the selected fragment sequences.

Meanwhile, the exemplary embodiments of the present disclosure may include a computer-readable recording medium equipped with programs for executing the methods described herein on a computer. The computer-readable recording medium may include program commands, local data files, local data structures, etc., which may be used alone or in combination. The computer-readable recording medium may be particularly designed or constructed for the purpose of the present disclosure, or may also be known and used by persons of ordinary skill in the computer software-related art. Examples of the computer-readable recording medium may include magnetic media such as hard disks, floppy disks and magnetic tapes, optical recording media such as CD-ROMs and DVDs, magneto-optical media such as floppy disks, and hardware devices, such as ROMs, RAMs and flash memories, which are particularly constructed to store and execute the program commands. Examples of the program commands may include high-level language codes capable of being executed by a computer using an interpreter, as well as machine codes such as those being constructed by compilers.

According to the exemplary embodiments of the present disclosure, the seeds (fragment sequences) can be selected upon alignment of the read sequence in consideration of an entire section of the read rather than a certain portion of the read, thereby improving mapping accuracy over the algorithms in which a portion of the read is contemplated.

Also, the mapping repeat number in the reference sequence for the respective fragment sequences can be defined, and lengths of seeds can also be expanded when the mapping repeat numbers of the seeds exceed a predetermined number, thereby improving mapping accuracy and simultaneously enhancing a mapping rate.

In addition, a global alignment time can be drastically reduced by dividing the reference sequence into a plurality of sections, selecting certain sections having a high probability of mapping reads from the divided sections and performing global alignment only in the corresponding sections.

Furthermore, a global alignment rate can be further enhanced by performing the direct global alignment on the fragment sequences having a high probability of forming a combination of the fragment sequences produced from the read, instead of finding the mapping positions and combinations of the fragment sequences. Also, the cycles of the unnecessary global alignment can be drastically reduced by memorizing a position at which the global alignment is performed so as to prevent the global alignment from being repeatedly performed at other positions adjoining such a position.

It will be apparent to those skilled in the art that various modifications can be made to the above-described exemplary embodiments of the present disclosure without departing from the spirit or scope of the present disclosure. Thus, it is intended that the present disclosure covers all such modifications provided they come within the scope of the appended claims and their equivalents.

What is claimed is:

1. A system, intended for use in aligning a genome sequence, the system comprising a computer executing program commands and thereby implementing:
a fragment sequence production unit configured to produce a plurality of fragment sequences from a read;
a filtering unit configured to constitute, from among the produced plurality of fragment sequences, a candidate fragment sequence group including mapped fragment sequences, of the plurality of fragment sequences, that map to a reference sequence;
a mapping number calculation unit configured to:
divide the reference sequence into a plurality of reference sequence sections; and
calculate total mapping numbers of the candidate fragment sequence group with respect to the reference sequence sections; and
an alignment unit configured to:
select ones of the reference sequence sections in which the calculated total mapping numbers are at least a predetermined reference number; and
perform a global alignment operation on the read with respect to the selected ones of the reference sequence sections.

2. The system of claim 1, wherein the fragment sequence production unit is further configured to produce the fragment sequences by reading a value of the read by a predetermined size, while advancing from a first base of the read sequence by a predetermined shift size.

3. The system of claim 1, wherein the mapped fragment sequences each have a number of unmatched bases, from the results of exact matching with the reference sequence, not exceeding a predetermined number.

4. The system of claim 1, further comprising a fragment sequence expansion unit configured to:
calculate respective mapping repeat numbers of the mapped fragment sequences in the reference sequence;
selects the mapped fragment sequences having respective mapping repeat numbers exceeding the predetermined number to provide selected fragment sequences; and
expand respective fragment sizes of the selected fragment sequences until the respective mapping repeat numbers do not exceed the predetermined number.

5. The system of claim 4, wherein the fragment sequence expansion unit is further configured to append bases, in the read, at positions corresponding to the beginnings or ends of the selected fragment sequences.

6. The system of claim 1, wherein the alignment unit is further configured to:
select ones of the candidate fragment sequence group mapped to the selected ones of the reference sequence sections to provide selected candidate fragment sequences; and
perform a global alignment operation on the read at mapping positions of the selected candidate fragment sequences in the reference sequence.

7. The system of claim 6, wherein the alignment unit is further configured to:
divide a selected section of the reference sequence sections into a plurality of subsections;
make a pre-performance determination as to whether a global alignment is pre-performed in the plurality of subsections to which positions in the reference sequence, on which the global alignment is to be performed, belong; and
perform the global alignment only when the pre-performance determination indicates that the global alignment is not pre-performed.

8. The system of claim 1, wherein:
the mapping number calculation unit is further configured to calculate respective total mapping lengths of the candidate fragment sequences for the respective reference sequence sections, together with the total mapping number; and
the alignment unit is further configured to:
further select, from the ones of the reference sequence sections in which the calculated total mapping numbers are at least a predetermined reference number, one or more further selected reference sequence sections in which the calculated total mapping lengths are at least a predetermined mapping length; and
perform a global alignment operation on the read with respect to the further selected reference sequence sections.

9. The system of claim 8, wherein, when the further selected reference sequence sections include a plurality of the reference sequence sections, the global alignment operation is sequentially performed on the read in an order based on one of the total mapping numbers and the total mapping lengths.

10. The system of claim 8, wherein the predetermined mapping length is greater than or equal to 2.

11. The system of claim 8, wherein the predetermined reference length is a relatively higher one of values calculated by the following expressions:
H=L−f*e−2s, and
H=f+s
where:
H represents the predetermined reference length,
L represents a length of a read,
f represents a length of a fragment sequence,
e represents a maximum error margin of the read, and
s represents a shift size of each fragment sequence.

12. The system of claim 11, wherein the reference length satisfies the following expression:
f+s≦H≦L−(f+s).

13. The system of claim 8, wherein the reference length is in a range of 16 to 59.

14. A method, intended for use in aligning a genome sequence, the method comprising:
using a fragment sequence production unit to produce a plurality of fragment sequences from a read;
using a filtering unit to constitute, from among the produced plurality of fragment sequences, a candidate fragment sequence group including mapped fragment sequences, of the plurality of fragment sequences, that map to a reference sequence;
using a mapping number calculation unit to:
divide the reference sequence into a plurality of reference sequence sections; and
calculate total mapping numbers of the candidate fragment sequence group with respect to the reference sequence sections; and
using an alignment unit to:
select ones of the reference sequence sections in which the calculated total mapping numbers are at least a predetermined reference number; and
perform a global alignment operation on the read with respect to the selected ones of the reference sequence sections;
wherein the mapped fragment sequences each have a number of unmatched bases, from the results of exact matching with the reference sequence, not exceeding a predetermined number.

15. The method of claim 14, wherein the producing of the fragment sequences is carried out by reading a value of the read by a predetermined size, while advancing from a first base of the read by a predetermined shift size.

16. The method of claim 14, wherein the constituting of the candidate fragment sequence group further comprises using a fragment sequence expansion unit to:
calculate respective mapping repeat numbers of the mapped fragment sequences in the reference sequence;
select the mapped fragment sequences having respective mapping repeat numbers exceeding the predetermined number to provide selected fragment sequences; and
expand respective fragment sizes of the selected fragment sequences until the respective mapping repeat numbers do not exceed the predetermined number;
wherein the expanding of the fragment sizes of the selected fragment sequences comprises appending bases, in the read, at positions corresponding to the beginnings or ends of the selected fragment sequences.

17. The method of claim 14, wherein the performing of the global alignment comprises:
selecting ones of the candidate fragment sequence group mapped to the selected ones of the reference sequence sections to provide selected candidate fragment sequences;
performing a global alignment operation on the read at mapping positions of the selected candidate fragment sequences in the reference sequence;
dividing each of the selected sections of the reference sequence sections into a plurality of subsections;
making a pre-performance determination as to whether a global alignment is pre-performed in the plurality of subsections to which positions in the reference sequence, on which the global alignment is to be performed, belong; and
performing the global alignment only when the pre-performance determination indicates that the global alignment is not pre-performed.

18. The method of claim 14, wherein:
the calculating of the total mapping numbers further comprises calculating respective total mapping lengths of the candidate fragment sequences for the respective reference sequence sections; and
the performing of the global alignment comprises:
further selecting, from the ones of the reference sequence sections in which the calculated total mapping numbers are at least a predetermined reference number, one or more further selected reference sequence sections in which the calculated total mapping lengths are at least a predetermined mapping length; and
performing a global alignment operation on the read with respect to the further selected reference sequence sections.

19. The method of claim 18, wherein, when the further selected reference sequence sections include a plurality of the reference sequence sections, the global alignment operation is sequentially performed on the read in an order based on one of the total mapping numbers and the total mapping lengths.

20. The method of claim 18, wherein the reference length is in a range of 16 to 59.
